(19) United States
(12) Patent Application Publication
(10) Pub. No.: US 2011/0297020 A1
(43) Pub. Date: Dec. 8, 2011

(54) SCREEN PRINTER AND SCREEN PRINTING METHOD

(75) Inventor: Tetsuya Tanaka, Yamanashi (JP)

(73) Assignee: PANASONIC CORPORATION, Osaka (JP)

(21) Appl. No.: 13/201,910

(22) PCT Filed: Jul. 13, 2010
(86) PCT No.: PCT/JP2010/004551

§ 371 Date: Aug. 17, 2011

(30) Foreign Application Priority Data
Aug. 6, 2009 (JP) 2009-182995

(51) Int. Cl. B05C 17/08

(52) U.S. Cl. 101/126; 101/129

(57) ABSTRACT

To provide a screen printer and a screen printing method that can assure a required degree of accuracy of print position when a type of work requiring a high degree of positional accuracy is taken as a target.

In relation to screen printing of a plurality of single-piece substrates 11 held on a carrier 10, a cavity portion 15 having print patterns assigned to the respective single-piece substrates 11 are provided on a mask plate 14, and a camera head unit 23 captures an image of the mask plate 14 and the single-piece substrates 11, to thus recognize the position of the mask plate and the positions of the respective single-piece substrates. The single-piece substrates 11 held by the carrier 10 are individually positioned to the cavity portion 15 and sequentially printed according to a result of recognition. It is thereby possible to eliminate a chance of occurrence of a positional error, which would otherwise be caused by variations in positions of the respective single-piece substrates 11 when the plurality of single-piece substrates 11 are positioned to the mask plate 14 by one operation.

### TECHNICAL FIELD

The present invention relates to a screen printer and a screen printing method for printing a work, such as a single-piece substrate placed on a carrier, with cream solder or paste like conductive paste.

### BACKGROUND ART

Screen printing has hitherto been widely used in a field of manufacture of electronic components as a method for printing an upper surface of a substrate with cream solder and paste like conductive paste. When a substrate to be printed corresponds to small-sized, separated, single-piece substrates, the plurality of single-piece substrates are printed while placed on a handling carrier. A carrier frequently used for such screen printing has a configuration in which a rectangular, plate-like member is equipped with a work placement portion for holding a substrate and a work (see Patent Document 1).

In an embodiment described in connection with Patent Document 1, single-piece substrates are fitted into corresponding work mount portions set on a carrier, and two mutually-opposing corners of the respective single-piece substrates are pinched with positioning pins, whereby the respective single-piece substrates are positioned within each of the work mount portions. The plurality of single-piece substrates that are held on the carrier and individually positioned in the manner as mentioned above are printed with paste by one operation.

### RELATED ART DOCUMENT

### Patent Document

Patent Document 1: JP-A-2008-142949

### DISCLOSURE OF THE INVENTION

### Problem that the Invention is to Solve

With a recent progress in miniaturization and sophistication of mobile electronic devices, like portable phones, components to be mounted have been sought than ever to become smaller in shape and packaged at higher densities. To this end, a packaging pitch on a work, such as a single piece substrate to be implemented in an electronic device, also becomes smaller, and a high degree of positioning accuracy has become demanded on the occasion of screen printing. However, in the related art including the foregoing embodiment of the Patent Document, techniques for performing positioning operation by mechanical section, like a pinching technique for pinching a single-piece substrate with pins, are dominant, and hence positioning accuracy that can be accomplished has a limitation. For these reasons, when a type of work requiring a high degree of positioning accuracy is subjected to related-art screen printing, it has been difficult to assure a required degree of print position accuracy.

Accordingly, when a type of work requiring a high degree of positioning accuracy is taken as a target, the present invention is to provide a screen printer and a screen printing method that make it possible to assure a required degree of print position accuracy.

### Means for Solving the Problem

A screen printer of the present invention corresponds to a screen printer that sequentially, individually brings a plurality of works that are placed on a carrier into contact with a mask plate from a lower surface side thereof and that causes a squeegee to perform sliding action on the mask plate supplied with paste, so as to print the works with the paste, the printer comprising: a cavity portion that is provided so as to protrude downwardly from the lower surface of the mask plate and that has a print pattern assigned to a single work; a carrier transport mechanism that carries the works into a print position for a screen print mechanism along with the carrier and that carries the printed works out of the print position along with the carrier; and a positioning section that individually positions the works, which are held on the carrier set at a position below the mask plate, to the cavity portion.

A screen printing method of the present invention corresponds to a screen printing method for printing a plurality of works with paste by sequentially, individually bringing the plurality of works held on a carrier into contact with a lower surface of a mask plate having a cavity portion that downwardly protrudes from the lower surface of the mask plate and that has print patterns assigned to respective single works, the method comprising: a carrier carry-in process of carrying the works into a print position for a screen print mechanism along with the carrier; a positioning process of individually positioning the works laid on the carrier to the cavity portion; a work contact process of bringing the works into contact with a lower surface of the cavity portion; a print process of causing a squeegee to slide over the mask plate supplied with paste, so as to print the work with the paste by the print pattern; and a carrier carry-out process of carrying the printed works from the print position along with the carrier.

### Advantage of the Invention

In relation to screen printing of a plurality of works held on a carrier, a cavity portion having print patterns assigned to respective single works are provided on a mask plate. The single works held by the carrier are individually positioned to the cavity portion and sequentially printed. It is thereby possible to eliminate a chance of occurrence of a positional error, which would otherwise be caused by variations in positions of the respective works when the plurality of works are positioned to the mask plate by one operation. When a type of work requiring a high degree of positional accuracy is taken as a target of printing, a required degree of positional accuracy for printing can be assured.

### BRIEF DESCRIPTION OF THE DRAWINGS

FIG. 1 is a side view of a screen printer of an embodiment of the present invention.

FIG. 2 is a front view of the screen printer of the embodiment of the present invention.

FIGS. 3(a) and (b) are partial plan views of the screen printer of the embodiment of the present invention.

FIGS. 4(a) and (b) are descriptive views of a structure of a carrier used in the screen printer of the embodiment of the present invention.

FIG. 5 is a partial cross sectional view of the screen printer of the embodiment of the present invention.

FIG. 6 is a portion diagram showing a configuration of a control system of the screen printer of the embodiment of the present invention.

FIGS. 7(a), (b), (c), and (d) are descriptive views of processes of a screen printing method of the embodiment of the present invention.

FIGS. 8(a), (b), and (c) are descriptive views of the processes of the screen printing method of the embodiment of the present invention.

### EMBODIMENT FOR IMPLEMENTING THE INVENTION

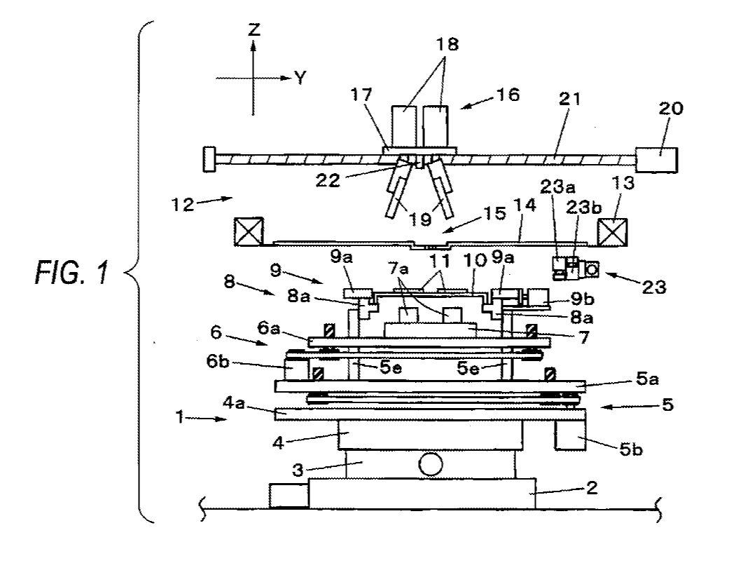

An embodiment of the present invention is now described by reference to the drawings. First, by reference to FIGS. 1, 2, 3(a), and 3(b), a structure of a screen printer is described. The screen printer has a function of printing upper surfaces of a plurality of single-piece substrates, which are held on a carrier and which serve as works, with cream solder and component bonding paste, like conductive paste.

In FIG. 1, the screen printer is configured such that a screen print mechanism 12 is placed at an elevated position above a carrier positioning portion 1. The carrier positioning portion 1 is built by piling a Y-axis table 2, an X-axis table 3, and a θ-axis table 4 into layers and also combining together a first Z-axis table 5 and a second Z-axis tale 6 on an upper surface side of a horizontal base plate 4a placed on an upper surface of the θ-axis table 4.

The first Z-axis table 5 has a horizontal base plate 5a, and the base plate 5a is caused to ascend or descend by a Z-axis elevation mechanism employing an elevation motor 5b as a drive source. A pair of vertical frames 5e stand upright on the base plate 5a, and two transport rails 8a making up a carrier transport mechanism 8 are held by upper ends of the respective vertical frames 5e. The transport rails 8a are laid in parallel along a direction of transport of a carrier (i.e., a direction X: a direction perpendicular to a drawing sheet of FIG. 1). Both ends of a carrier 10 on which a plurality of single-piece substrates 11 to be printed are set are conveyed while being supported by a transport conveyor placed on the transport rails 8a.

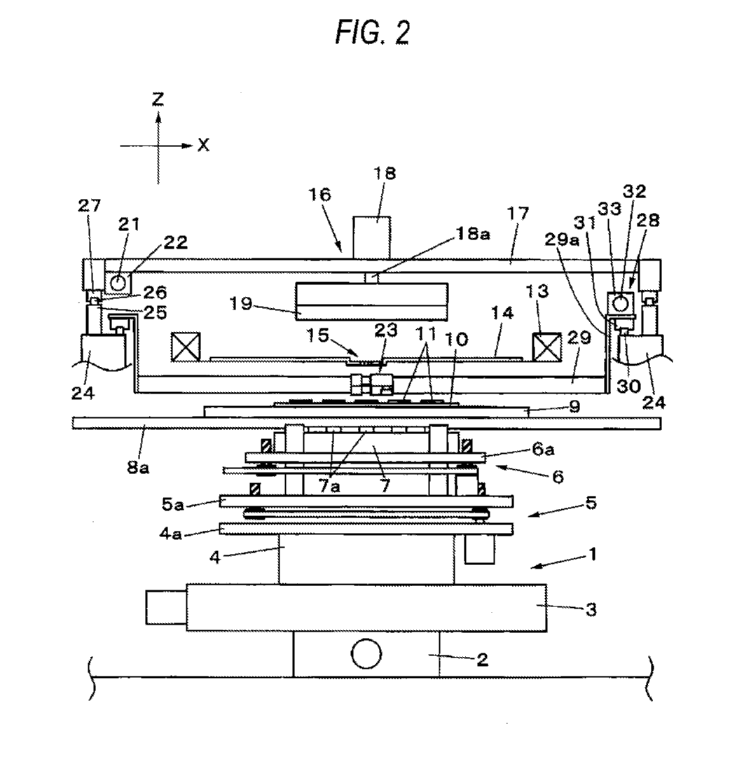

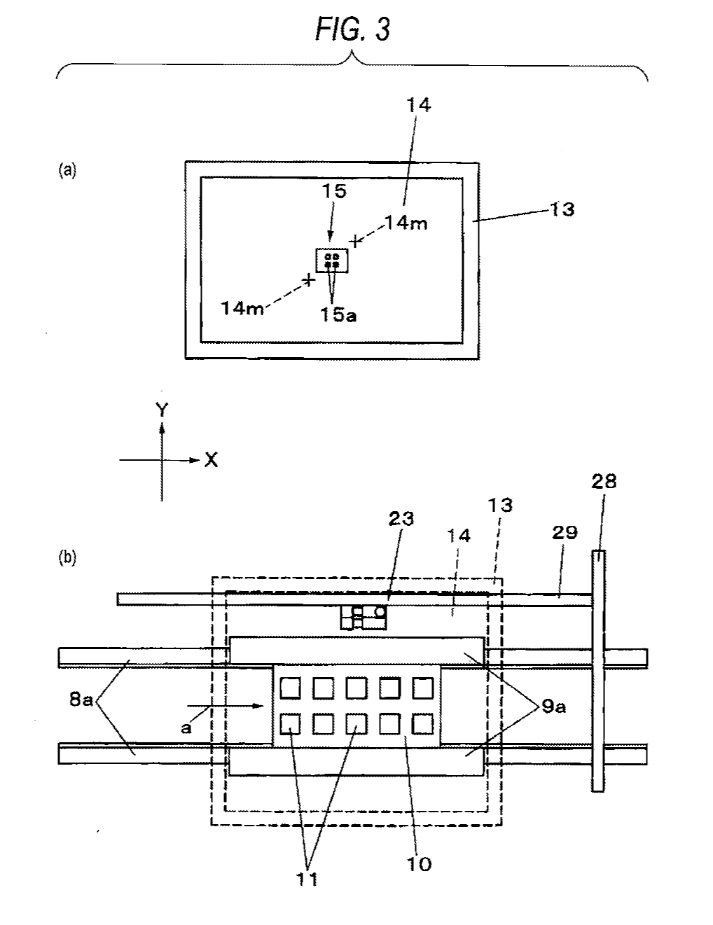

The carrier 10 held by the carrier transport mechanism 8 can be elevated and lowered with reference to the screen print mechanism 12 to be described later, along with the transport rails 8a by actuation of the first Z-axis table 5. As shown in FIGS. 2, 3(a), and 3(b), the carrier conveyance mechanism 8 extends to both an upstream side (FIGS. 2, 3(a), and a left side of 3(b)) and a downstream side. The carrier 10 carried into the screen printer from the upstream side (refer to an arrow “a” shown in FIG. 3(b)) is transported by the carrier transport mechanism 8 and positioned at a print position on the screen print mechanism 12 by the carrier positioning portion 1. The carrier 10 printed by the screen print mechanism 12 is transported to the downstream side by the carrier transport mechanism 8. Specifically, the carrier transport mechanism 8 carries the single-piece substrates 11 to respective print positions on the screen print mechanism 12 in conjunction with the carrier 10, as well as carrying out the printed single-piece substrates 11 from their print positions along with the carrier 10.

The second Z-axis table 6 has a horizontal base plate 6a interposed between the carrier transport mechanism 8 and the base plate 5a. The base plate 6a is elevated and lowered by a Z-axis elevation mechanism that uses an elevation motor 6b as a drive source. A lower receiving portion 7 is set on an upper surface of the base plate 6a. A plurality of contact members 7a are arranged on an upper surface of the lower receiving portion 7 so as to match a layout of the single-piece substrates 11 on the carrier 10. The contact member 7a is elevated along with the lower receiving portion 7 by actuation of the second Z-axis table 6. The contact member 7a thereupon contacts lower surfaces of the respective single-piece substrates 11 held on the carrier 10, thereby raising the single-piece substrates from the carrier 10. Vacuum suction holes (omitted from the drawings) are provided in an upper surface of the contact member 7a. The single-piece substrates 11 are held by suction by the contact members 7a, whereby a horizontal position of the single-piece substrates 11 is kept.

A cramp mechanism 9 is placed on an upper surface of the carrier transport mechanism 8. The cramp mechanism 9 has two cramp members 9a symmetrically arranged along a horizontal direction. One of the cramp members 9a is caused to advance or recede in a direction Y by a drive mechanism 9b, whereby both sides of the carrier 10 are clamped and fastened (see also FIGS. 3(a) and (b)).

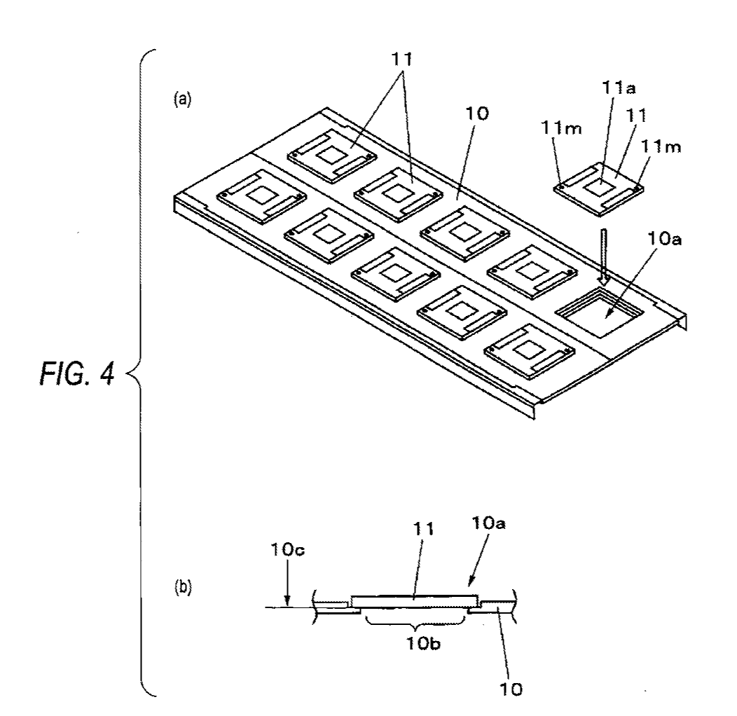

The single-piece substrates 11 that will be objects of printing and the carrier 10 used for handling the single-piece substrates 11 are now described by reference to FIGS. 4(a) and (b). As shown in FIG. 4(a), the carrier 10 is fabricated into a shape that makes it possible for the carrier transport mechanism 8 to perform transport, by bending both ends of an oblong metal plate in a downward direction. A plurality of work mount portions 10a on which the single-piece substrates 11 are individually mounted are arranged in a predetermined layout (a 2-by-5 matrix) on the carrier 10. The single-piece substrates 11 are small-sized, rectangular (square) single-piece substrates used for manufacturing semiconductor packages, like BGAs. In order to take the plurality of single-piece substrates 11 as objects of printing in a single work process, the single-piece substrates 11 are handled while remaining placed respectively on the plurality of work mount portions 10a formed in the carrier 10. Work reference marks 11m used for ascertaining a position of an individual single-piece substrate 11 are provided at diagonal positions of each of the single-piece substrates 11.

As shown in FIG. 4(b), each of the work mount portions 10a is formed into a square shape commensurate with a planar shape of each of the single-piece substrates 11. Since a lower surface of each of the single-piece substrates 11 is received by the corresponding contact member 7a, the work mount portion 10a is formed into a shape such that a bottom of each of the work mount portions assumes an aperture 10b. A work support surface 10c for supporting a lower surface of each of the single-piece substrates 11 is provided along a brim of each of the apertures 10b. The single-piece substrates 11 are supported by the respective work mount portions 10a in such a way that an edge of a lower surface of each of the single-piece substrates 11 is supported from below by the corresponding work support surface 10c.

The screen print mechanism 12 placed at an elevated position above the carrier positioning portion 1 is now described. In FIGS. 1, 2, 3(a), and 3(b), a mask plate 14 is stretched in a mask frame 13 held by a mask holder (omitted from the drawings). A cavity portion 15 is formed in the mask plate 14 in such a shape that a recess is formed in an upper surface of the mask plate and that a downward projection is formed at a corresponding position on a lower surface. As shown in FIGS. 3(a) and 3(b), pattern holes 15a used for printing a print land 11a of each of the single-piece substrates 11 with paste are formed in the cavity portion 15. Further, a pair of mask reference marks 14m that are used for ascertaining positions of the respective pattern holes 15a are formed at diagonal positions on a lower surface of the mask plate 14 in a neighborhood of the cavity portion 15.

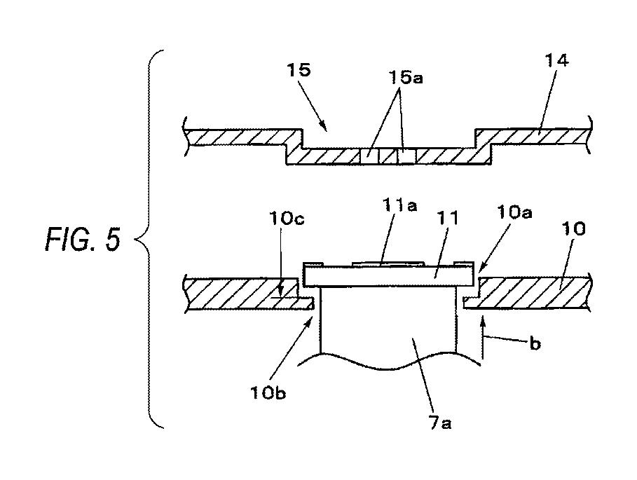

As shown in FIG. 5, positions of the respective pattern holes 15a provided in the cavity portion 15 of the mask plate 14 correspond to paste print positions on each of the print lands 11a provided for the respective single-piece substrates 11. The plurality of pattern holes 15a make up a print pattern used for printing the respective single-piece substrates 11 with paste. Specifically, a print pattern assigned to one single-piece substrate 11 is formed in the cavity portion 15. The plurality of single-piece substrates 11 arranged on the carrier 10 are screen-printed with paste by individually positioning the single-piece substrates 11 on the respective lower surfaces of the cavity portion 15 and sequentially bringing the single-piece substrates 11 into contact with the respective lower surfaces of the cavity portion.

First, the single-piece substrates 11 placed on the work mount portions 10a of the carrier 10 are raised from a lower surface side by the respective contact members 7a (designated by arrows “b”). The contact members 7a hold by suction the respective single-piece substrates 11 while the single-piece substrates are separated from the respective work support surfaces 10c and fix horizontal positions of the single-piece substrates 11. Next, the carrier positioning portion 1 is actuated, thereby horizontally positioning the single-piece substrates 11 to be printed to the cavity portion 15. Further, the single-piece substrates 11 are elevated by actuation of the first Z-axis table 5, to thus come into contact with the lower surfaces of the cavity portion 15.

The carrier 10 on which the plurality of single-piece substrates 11 are to be arranged is configured so as to have the work mount portion 10a simply including the apertures 10b and the work support surfaces 10c, such as that described in connection with the present embodiment. In addition, carriers having various functions, such as a carrier 10 having a function of supporting the single-piece substrates 11 from below and a carrier 10 having a function of fixing a horizontal position of each of the single-piece substrates, can be used. When the carrier 10 itself has the receiving function and the horizontal position fixing function, the contact member 7a becomes unnecessary.

A squeegee unit 16 is disposed at an elevated position above the mask plate 14. The squeegee unit 16 is configured such that two squeegee elevation mechanisms 18 for elevating and lowering a pair of mutually-disposed squeegees 19 are disposed on a horizontal plate 17. The squeegees 19 are caused to ascend or descend by activation of the squeegee elevation mechanisms 18, thereby coming into contact with an upper surface of the mask plate 14. A feed screw 21 that is rotationally actuated by a squeegee travel motor 20 is screw-engaged with a nut 22 fixed into a lower surface of the plate 17. The squeegees 19 are horizontally moved along the direction Y in conjunction with the plate 17 by activation of the squeegee travel motor 20. As shown in FIG. 2, guide rails 26 are laid along the direction Y (see FIG. 3) on respective brackets 25 provided on respective vertical frames 24. Sliders 27 slidably fitted to the respective guide rails 26 are coupled to both ends of the plate 17. The squeegee unit 16 is thereby slidably along the direction Y.

In FIG. 2, guide rails 30 are laid on the respective vertical frames 24 along the direction Y. Sliders 31 slidably fitted to the respective guide rails 30 are coupled to a head X-axis table 29 by way of respective brackets 29a. The head X-axis table 29 is thereby slidably in the direction Y (see FIG. 3). The head X-axis table 29 is horizontally moved in the direction Y (see FIG. 3) by a head Y-axis travel mechanism 28 built from a nut 33, a feed screw 32, and a head travel motor (omitted from the drawings) that rotationally actuates the feed screw 32.

As shown in FIGS. 1 and 2, the head X-axis table 29 is equipped with a camera head unit 23. The camera head unit 23 includes a work recognition camera 23a for capturing an image of the single-piece substrates 11 held by the carrier 10 from above and a mask recognition camera 23b for capturing an image of the mask plate 14 from its lower surface. The camera head unit 23 is moved by actuation of the head Y-axis travel mechanism 28 and the head X-axis table 29, whereby the work recognition camera 23a and the mask recognition camera 23b are moved so as to advance toward spacing between the mask plate 14 and the carrier 10.

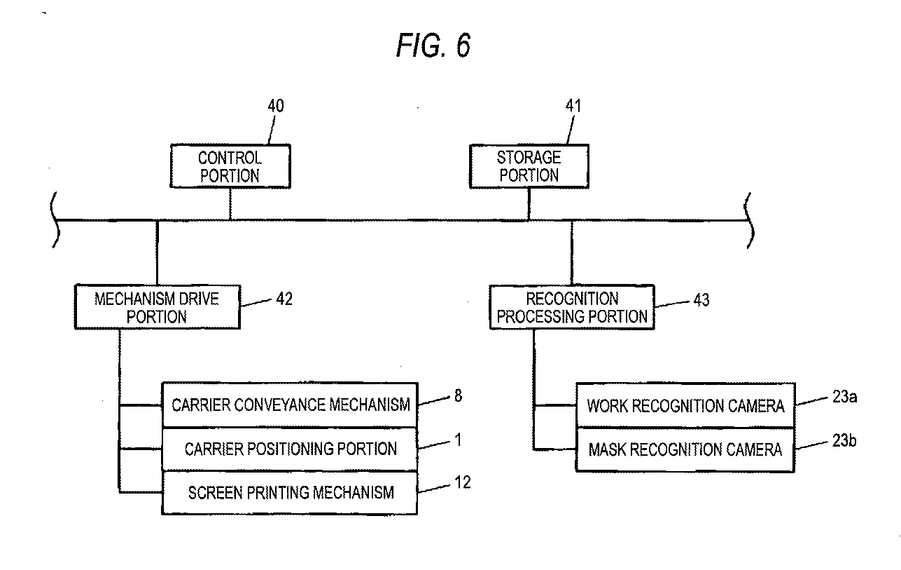

The work recognition camera 23a captures each of images of the work reference marks 11m (see FIG. 4) formed on the respective single-piece substrates 11, and a recognition processing portion 43 (FIG. 6) subjects an imaging result to recognition processing, thereby detecting positions of the print lands 11a. The mask recognition camera 23b captures an image of the mask reference marks 14m (see FIG. 3(a)) formed on the mask plate 14. The recognition processing portion 43 (FIG. 6) performs recognition processing of an imaging result, whereby positions of the pattern holes 15a in the cavity portion 15 are detected. When the camera head unit 23 does not recognize the single-piece substrates 11 and the mask plate 14, the camera head unit 23 is situated at a position receded sideways from the elevated position above the carrier positioning portion 1, as shown in FIG. 1.

A configuration of the control system is now described by reference to FIG. 6. In FIG. 6, a control portion 40 controls respective portions to be described below, according to an operation program, a processing program, and various types of data stored in a storage portion 41. The single-piece substrates 11 held by the carrier 10 are subjected, as targets, to screen print processing. A mechanism drive portion 42 is controlled by the control portion 40, to thus actuate the carrier transport mechanism 8, the carrier positioning portion 1, and the screen print mechanism 12.

The recognition processing portion 43 subjects data pertaining to an image captured by the work recognition camera 23a to recognition processing, thereby recognizing positions of the work reference marks 11m and detecting positions of the single-piece substrates 11. Therefore, the work recognition camera 23a and the recognition processing portion 43 make up a work recognition portion that optically recognizes the work reference marks 11m provided on the single-piece substrates 11 that are works. The recognition processing portion 43 subjects data pertaining to an image captured by the mask recognition camera 23b to recognition processing, thereby recognizing positions of the mask reference marks 14m and detecting positions of the cavity portions 15. Therefore, the mask recognition camera 23b and the recognition processing portion 43 make up a mask recognition portion that optically recognizes the mask reference marks 14m provided on the mask plate 14.

According to the recognition result of the mask recognition portion and the recognition result of the work recognition portion, the control portion 40 controls the carrier positioning portion 1. The single-piece substrates 11 held by suction with the contact members 7a placed on the carrier 10 can be individually positioned to the cavity portion 15 protruding from a lower surface of the mask plate 14. Specifically, the mask recognition portion, the work recognition portion, the carrier positioning portion 1, and the control portion 40 that have previously been described make up positioning section that individually positions the single-piece substrates 11, placed on the carrier 10 located below the mask plate 14 to the cavity portion 15.

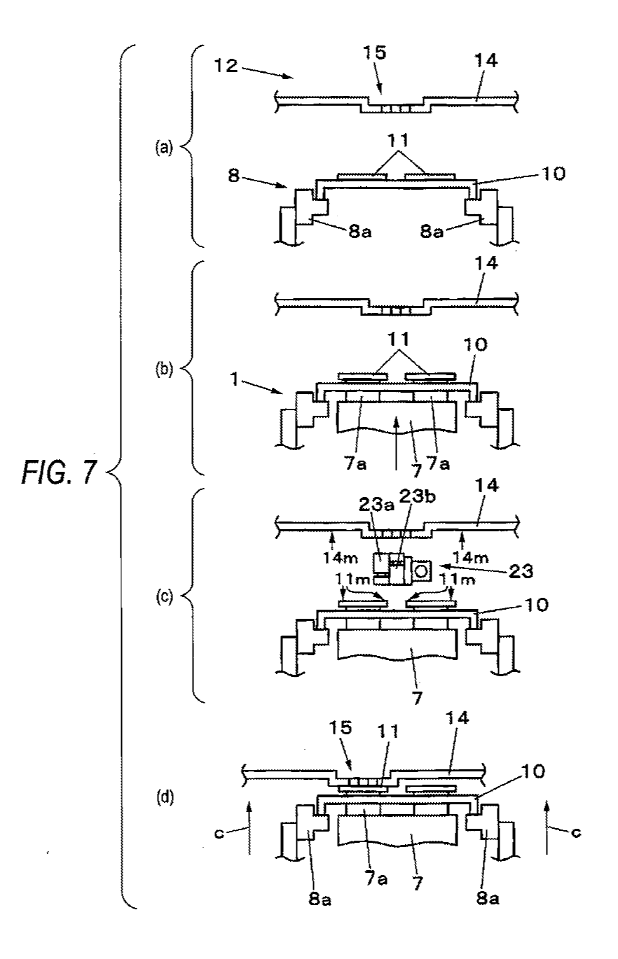

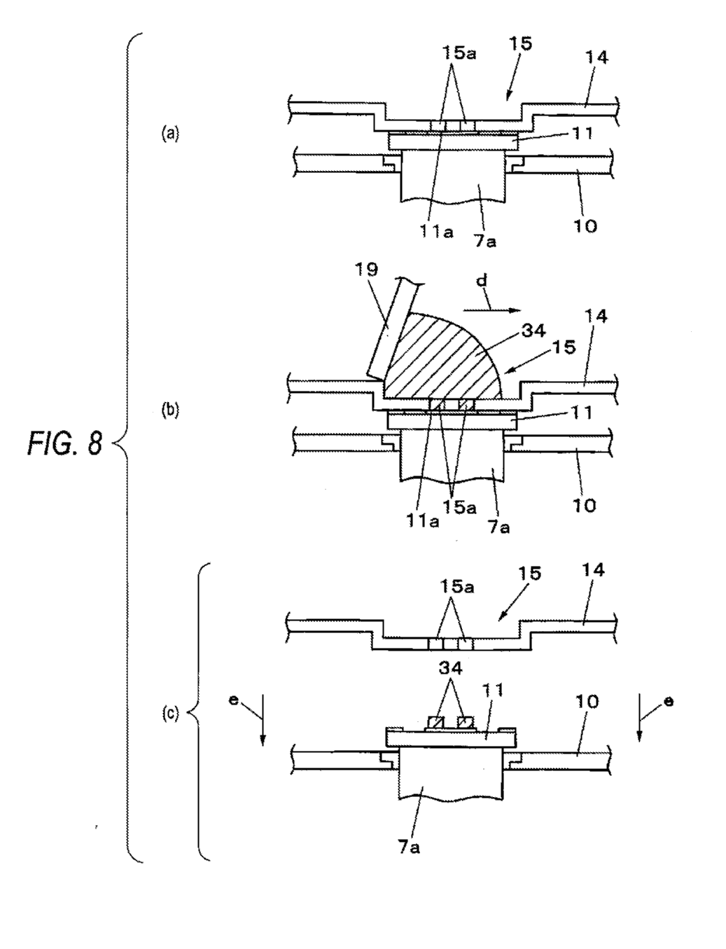

By reference to FIGS. 7 and 8, explanations are now given to a screen printing method by which the screen printer prints the plurality of single-piece substrates 11 held by the carrier 10 with component bonding paste. In the embodiment, screen printing is performed by sequentially, individually bringing the single-piece substrate 11 into contact with the mask plate 14 having the cavity portion 15 assigned to one single-piece substrate 11.

First, as shown in FIG. 7(a), the plurality of single-piece substrates 11 held by the carrier 10 are carried to a print position for the screen print mechanism 12; namely, a position located below the mask plate 14, along the transport rails 8a of the carrier transport mechanism 8 along with the carrier 10 (a carrier carry-in process). Next, as shown in FIG. 7(b), the lower receiving portion 7 is elevated, to thus raise the respective single-piece substrates 11 held by the carrier 10 by the contact members 7a. The contact members 7a hold by suction the respective single-piece substrates 11.

Subsequently, the single-piece substrates 11 placed on the carrier 10 are individually positioned to the cavity portion 15 of the mask plate 14 (a positioning process). Processing pertaining to a positioning process is performed as follows. Specifically, as shown in FIG. 7(c), the camera head unit 23 is caused to advance to position between the mask plate 14 and the carrier 10. The camera head unit captures an image of the mask reference marks 14m provided on the mask plate 14 by use of the mask recognition camera 23b, so as to optically recognize the mask reference marks. Further, the work recognition camera 23a captures an image of the work reference marks 11m provided on the respective single-piece substrates 11, thereby optically recognizing the work reference marks 11m provided on the single-piece work substrates 11.

The control portion 40 controls the carrier positioning portion 1 according to a result of recognition of the mask reference marks 14m and a result of recognition of the work reference marks 11m, thereby horizontally moving the single-piece substrates 11 and horizontally positioning the respective single-piece substrates 11 to the cavity portion 15. Subsequently, the first Z-axis table 5 is actuated, thereby elevating the carrier 10 and the lower receiving portion 7 (designated by an arrow “c”), as shown in FIG. 7(d). The single-piece substrates 11 are thereby brought into contact with the respective cavity portion 15 from their lower surface sides (a work contact process).

As shown in FIG. 8(a), the pattern holes 15a are thereby into position on the print land 11a on the upper surface of each of the single-piece substrates 11. The squeegee 19 is caused to slide, in a squeeging direction (as designated by arrow “d”) over the cavity portion 15 supplied with paste 34. As shown in FIG. 8(b), the pattern holes 15a in the cavity portion 15 are filled with the paste 34. Plate release operation (as designated by arrow “e”) involving actuating the first Z-axis table 5, to thus lower the single-piece substrates 11, is performed, whereby the single-piece substrates 11 are printed with the paste 34 by the print pattern, as shown in FIG. 8(c) (a print process).

Subsequently, other yet-to-be-printed single-piece substrates 11 are subjected to repeated performance of operations shown in FIGS. 7(c) to 8(c). In the course of sequential, repeated performance of screen printing of the plurality of single-piece substrates 11, the paste 34 is printed by the cavity portion 15 projecting from the lower surface of the mask plate 14. Therefore, printing operation can be repeatedly, continually performed without involvement of occurrence of a defect, which would otherwise be caused when the paste 34 on the upper surfaces of the printed single-piece substrates 11 contacts and adheres to the lower surface of the mask plate 14.

The work recognition camera 23a can capture an image of the single-piece substrates 11 for each printing operation of one single-piece substrate 11. Alternatively, an image of all of the single-piece substrates 11 can also be captured by one imaging operation involving advancement of the camera head unit 23. So long as operation for printing all of the single-piece substrates 11 with the paste 34 has ended as mentioned above, the printed single-piece substrates 11 are carried out from the print position along with the carrier 10 (a carrier carry-out process).

As mentioned above, the present invention is made at screen printing intended for the plurality of carriers 10 placed on the carrier 10. During printing operation, the cavity portion 15 having print patterns formed so as to be assigned to respective carriers 10 are provided on the mask pattern 14. The single-piece substrates 11 placed on the respective carriers 10 are individually positioned to the cavity portion 15 and sequentially printed. As a result, it is possible to eliminate a chance of occurrence of positional errors, which would otherwise be caused by variations in positions of the respective single-piece substrates 11 when the plurality of single-piece substrates 11 are positioned on the mask plate 14 by one operation. Therefore, when a type of work requiring a high degree of positional accuracy is taken as a target of printing, a required degree of positional accuracy for printing can be assured.

The present patent application is based on Japanese Patent Application (JP-2009-182995) filed on August 6, 2009, the entire subject matter of which is incorporated herein by reference.

### INDUSTRIAL APPLICABILITY

The screen printer and the screen printing method of the present invention yield an advantage of the ability to assure a required degree of positional accuracy for printing when a type of work requiring a high degree of positioning accuracy is taken as a target. The screen printer and the screen printing method are useful in a field of screen printing, or the like, in which a single-piece of work held by a carrier is printed with cream solder and plate like conductive paste.

### DESCRIPTIONS OF THE REFERENCE NUMERALS AND SYMBOLS

1 CARRIER POSITIONING PORTION

8 CARRIER TRANSPORT MECHANISM

10 CARRIER

10a WORK MOUNT PORTION

11 SINGLE-PIECE SUBSTRATE

11m WORK REFERENCE MARKS

12 SCREEN PRINT MECHANISM

14 MASK PLATE

14m MASK REFERENCE MARKS

15 CAVITY PORTION

15a PATTERN HOLE

1. A screen printer that sequentially, individually brings a plurality of works that are placed on a carrier into contact with a mask plate from a lower surface side thereof and that causes a squeegee to perform sliding action on the mask plate supplied with paste, so as to print the works with the paste, the printer comprising:
a cavity portion that is provided so as to protrude downwardly from the lower surface of the mask plate and that has a print pattern assigned to a single work;
a carrier transport mechanism that carries the works into a print position for a screen print mechanism along with the carrier and that carries the printed works out of the print position along with the carrier; and
a positioning section that individually positions the works, which are placed on the carrier set at a position below the mask plate, to the cavity portion.

2. The screen printer according to claim 1, wherein the positioning section includes:
a mask recognition portion that optically recognizes mask reference marks provided on the mask plate;
a work recognition portion that optically recognizes work reference marks provided on the respective works;
a carrier positioning portion that holds and positions the carrier at a predetermined location; and
a control portion that controls the carrier positioning portion according to a recognition result of the mask recognition portion and a recognition result of the work recognition portion.

3. A screen printing method for printing a plurality of works with paste by sequentially, individually bringing the plurality of works that are placed on a carrier into contact with a lower surface of a mask plate having a cavity portion that downwardly protrudes from the lower surface of the mask plate and has print patterns assigned to respective single works, the method comprising:
a carrier carry-in process of carrying the works into a print position for a screen print mechanism along with the carrier;
a positioning process of individually positioning the works laid on the carrier to the cavity portion;
a work contact process of bringing the works into contact with a lower surface of the cavity portion;
a print process of causing a squeegee to slide over the mask plate supplied with paste, so as to print the work with the paste by the print pattern; and
a carrier carry-out process of carrying the printed works from the print position along with the carrier.

4. The screen printing method according to claim 3, wherein the positioning process includes optically recognizing mask reference marks provided on the mask plate and work reference marks provided for the respective works and controlling a carrier positioning portion that holds and positions the carrier to a predetermined position according to a recognition result of the mask reference mark and a recognition result of the work reference mark.
